(19) United States
(12) Patent Application Publication
(10) Pub. No.: US 2011/0086660 A1
(43) Pub. Date: Apr. 14, 2011

(54) CONTROL OF COEXISTING WIRELESS NETWORKS BASED ON PREDICTED TRANSMISSION ARRIVAL TIME

(75) Inventors: Yanjun SUN, Richardson, TX (US); Ariton E. XHAFA, Plano, TX (US); Xiaolin LU, Plano, TX (US); Assaf SELLA, Rishpon (IL); Josef PEERY, Ra'anana (IL)

(73) Assignee: TEXAS INSTRUMENTS INCORPORATED, Dallas, TX (US)

(21) Appl. No.: 12/903,910

(22) Filed: Oct. 13, 2010

Related U.S. Application Data
(60) Provisional application No. 61/251,000, filed on Oct. 13, 2009.

(51) Int. Cl. H04B 7/00

(52) U.S. Cl. 455/509

(57) ABSTRACT

A system and method for optimizing medium utilization with coexisting wireless networks is described herein. In one embodiment, a wireless device includes a first wireless transceiver, a second wireless transceiver, and logic configured to determine which of the first and second wireless transceivers is enabled at a given time. The first wireless transceiver is configured for operation with a first wireless network. The second wireless transceiver is configured for operation with a second wireless network coexisting with the first wireless network. The logic is further configured to predict an arrival time of a transmission from a different device and to enable the second wireless transceiver based on the predicted arrival time.

### CROSS-REFERENCE TO RELATED APPLICATION

The present application claims priority to U.S. Provisional Patent Application No. 61/251,000, filed on Oct. 13, 2009, entitled “Bit Polling Schedule Aware Resource Allocation in Coexisting Networks” which is hereby incorporated herein by reference in its entirety.

### BACKGROUND

As wireless technologies proliferate, mobile wireless devices incorporate a multiplicity of different wireless standards. For example, a cellular telephone can accommodate a cellular network (e.g., Universal Mobile Telecommunications System), a wireless local area network (“WLAN”), such as IEEE 802.11, and a wireless personal area network (“WPAN”) (e.g., a Bluetooth® network). Including WPAN access makes utilization of a wireless device more convenient by allowing use of wireless headsets and other short-range wireless appliances.

Some of the various wireless standards adopted for use in mobile devices use adjacent and/or overlapping portions of the wireless spectrum. For example, both Bluetooth networks and IEEE 802.11b/g/n networks occupy the 2.45 GHz band.

### SUMMARY

A system and method for optimizing medium utilization with coexisting wireless networks is described herein. In one embodiment, a wireless device includes a first wireless transceiver, a second wireless transceiver, and logic configured to determine which of the first and second wireless transceivers is enabled at a given time. The first wireless transceiver is configured for operation with a first wireless network. The second wireless transceiver is configured for operation with a second wireless network coexisting with the first wireless network. The logic is further configured to predict an arrival time of a transmission from a different device and to enable the second wireless transceiver based on the predicted arrival time.

In another embodiment, a method includes determining, by a first wireless device, a predicted arrival time of a transmission from a second wireless device. A first wireless transceiver in the first wireless device is enabled based on the predicted arrival time.

In a further embodiment, a system includes a master wireless device and a slave wireless device. The slave wireless device is configured to operate on a first wireless network and to operate on a second wireless network different from the first wireless network. The master wireless device is configured to emit transmissions determining when the slave device transmits on the second network. The slave device is further configured to predict an arrival time of a transmission by the master device, and to enable operation on the second network based on the predicted arrival time.

In a yet further embodiment, an apparatus includes a transmission analyzer and a transmission predictor. The transmission analyzer is configured to gather timing information associated with transmissions by a master device. The transmission predictor is configured to determine an estimated arrival time of a transmission by the master device based on the gathered timing information.

### BRIEF DESCRIPTION OF THE DRAWINGS

For a detailed description of exemplary embodiments of the invention, reference will now be made to the accompanying drawings in which:

FIG. 1 shows a wireless system including wireless devices configured for operation on coexisting wireless networks in accordance with various embodiments;

FIG. 2 shows a diagram of activity relative to a slave device configured for operation on coexisting wireless networks in accordance with various embodiments;

FIG. 3 shows a block diagram of a slave device configured for operation on coexisting wireless networks in accordance with various embodiments; and

FIG. 4 shows a flow diagram for a method for controlling access to coexisting wireless networks in a slave device in accordance with various embodiments.

### NOTATION AND NOMENCLATURE

Certain terms are used throughout the following description and claims to refer to particular system components. As one skilled in the art will appreciate, companies may refer to the same component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Next generation mobile devices implement a plurality of wireless technologies to access different networks such as WiMAX® networks, wireless local area networks (“WLAN”) networks (e.g., IEEE 802.11b/g/n networks), LTE® networks, wireless universal serial bus, or Bluetooth® (“BT”) networks, etc. Such devices are referred to herein as “combo” devices. While increased access to these technologies benefit users and operators alike, interference among different technologies, particularly onboard a single combo device, introduces difficulties during concurrent operation of these technologies. For example, WLAN (in 2.4-2.5 GHz) and WiMAX (in 2.3-2.4 GHz and 2.5-2.7 GHz) technologies operate at relatively close frequency bands with respect to each other—so close, that the out-of-band emission by either technology may saturate the receiver of the other technology resulting in potential blocking. Thus, the interference between different technologies operating in the same combo device creates coexistence problems.

Coexistence problems in a wireless device may be addressed by time multiplexing access to the medium by the various transceivers associated with the different networks. Unfortunately, time multiplexing can result in inefficient use of the medium, thereby reducing performance on at least one of the coexisting wireless networks.

Embodiments of the present disclosure provide improved performance in systems using coexisting wireless networks where one of the networks implements a master-slave protocol. In a wireless network implementing a master-slave protocol (e.g., a BT network), slave device transmission is triggered by reception of a polling frame transmitted by a master device. Embodiments disclosed herein are configured to learn the transmission timing pattern of poll frames emitted by a master device, and enable access to the wireless network including the master device immediately prior to (i.e., in sufficient time to configure the transceiver to properly receive the predicted frame) the predicted arrival time of the poll frame. Access to a different wireless network is enabled up to the predicted arrival time of the poll frame, thereby providing improved utilization of the different wireless network.

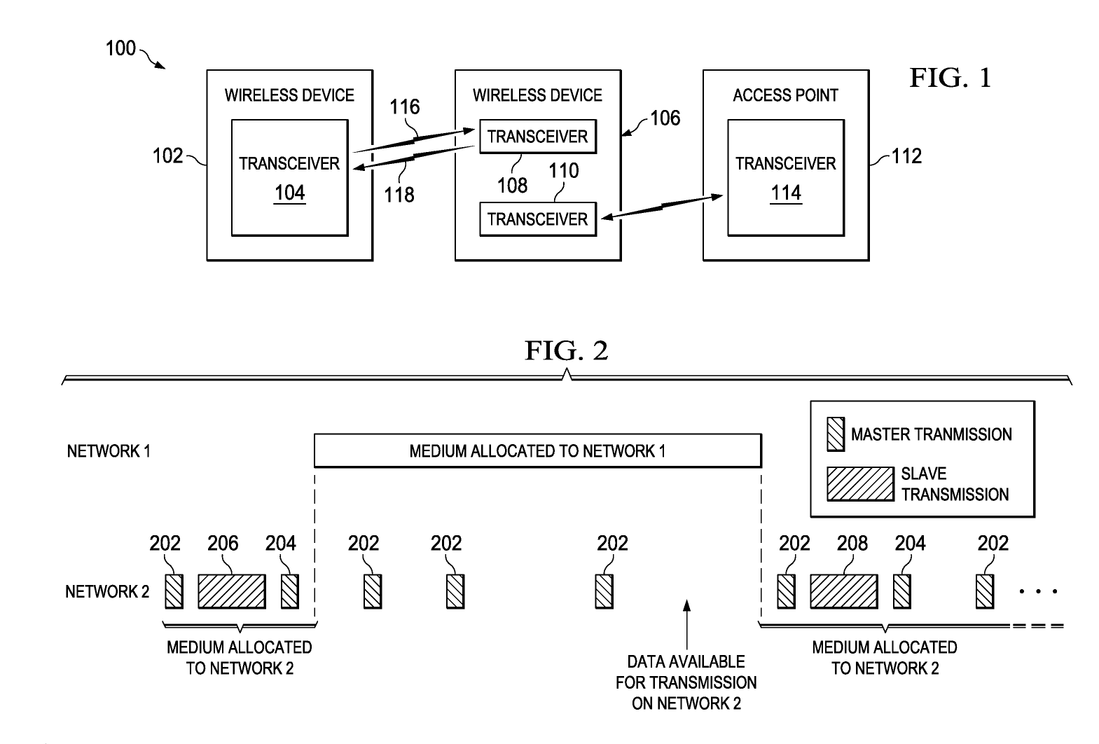

FIG. 1 shows a wireless system 100 including a wireless device 106 configured for operation on coexisting wireless networks in accordance with various embodiments. The wireless system 100 also includes an access point 112 and a wireless device 102. The access point 112 includes a wireless transceiver 114 that is configured to communicate with the wireless device 106 via a first wireless network. Similarly, the wireless device 106 includes a transceiver 110 that is configured to provide communication via the first wireless network. In some embodiments of the system 100, the access point 112 and the wireless device 106 are configured to communicate with one another in accordance with a WLAN protocol (e.g., IEEE 802.11b/g/n). In some embodiments, the transceivers 110, 114 are configured for communication according to another standard (e.g., WiMAX).

The wireless device 106 also includes a transceiver 108 configured for communication via a second wireless network using a protocol different from that of the first wireless network. The first and second transceivers may interfere with one another if operated concurrently on adjacent or overlapping bands. Consequently the wireless device 106 may time multiplex operation of the transceivers 108, 110 to mitigate such interference.

The wireless device 102 includes a transceiver 104 configured to communicate with the wireless device 106 via the second wireless network. The wireless device 102 is a master device on the second network, and can control the timing of transmissions 118 by the wireless device 106 (i.e., the slave device) on the second wireless network by transmitting polling frames 116. Reception of a polling frame by the wireless device 106 indicates that the transceiver 108 can be enabled to transmit via the second wireless network. In some embodiments of the system 100, the second wireless network is a BT network. In other embodiments of the system 100, the second wireless network is a network according to another standard utilizing a master-slave protocol.

To optimize medium access by the transceivers 108, 110, the wireless device 106 monitors polling frame transmissions 116 by the wireless device 102, analyzes the timing of the transmissions 116, and identifies a pattern of the transmissions 116. The wireless device 106 internally approximates the transmission 116 timing to predict the arrival time of a poll frame, and enables the transceiver 108 to access the medium a predetermined time interval prior to the predicted arrival time of the poll frame. The transceiver 110 is enabled to access the first wireless network up to the time that the transceiver 108 is enabled, thereby allocating medium time to the transceiver 110 that would be lost in a system not basing time multiplexing on poll frame prediction.

FIG. 2 shows a diagram of activity relative to the slave device 106, which is configured for operation with coexisting wireless networks in accordance with various embodiments. Activity related to the first wireless network and activity related to the second wireless network is illustrated. With regard to the second wireless network, the master device 102 transmits polling frames 202 for reception by the slave device 106. The slave device 106 may only initiate transmission of a packet 206 after a poll frame 202 from the master device 102 is received. Thus, the slave device 106 enables the transceiver 108 to receive a poll frame 202 when the slave device 106 has data available for transmission via the second network. The intervals between poll frame 202 transmissions can vary as shown, and can be in the range of 10 s of milliseconds in some instances. Consequently, enabling the transceiver 108 (and disabling the transceiver 110) at an inopportune time to await reception of a poll frame 202 can result in an undesirable waste of medium access time.

In FIG. 2, the slave device 106 transmits the packet 206 after reception of the preceding poll frame 202. An acknowledgement frame 204 is transmitted by the master device 102 and received by the slave device 106 after transmission of the packet 206. As shown the medium is allocated to the second network until after reception of the acknowledgement packet 204, at which time the medium is allocated to the first network (i.e., the transceivers 110/108 are respectively enabled and disabled). While the medium is allocated to the first network, the master device 102 continues to transmit poll frames 202 according to a timing pattern determined by the master device 102.

The intervals between poll frame 202 transmissions and the patterns of poll frame 202 transmission timing may vary for different master devices (e.g., master devices produced by different manufacturers). For various master devices 102, the time interval between poll frames 202 may increase linearly, exponentially, or according to a different pattern. The slave device 106 monitors the poll frame 202 transmissions, and identifies the pattern of poll frame 202 transmission timing used by the master device 102. Having identified the pattern of transmission timing of the master device 102, the slave device 106 can predict the arrival time of a poll frame 202, and enable the transceiver 108 just prior to the predicted arrival time.

In FIG. 2, data (e.g., advanced audio distribution profile “A2DP” data) becomes available for transmission on the second network while the medium is allocated to the first network. Rather than immediately enabling the transceiver 108 to await reception of the next poll frame 202, embodiments of the slave device 106 predict the arrival time of the next poll frame 202 and allocate the medium to the second network (i.e., enable transceiver 108) shortly before the predicted arrival time. After reception of the poll frame 202, the data packet 208 is transmitted. Thus, access to the first network is optimized by enabling the transceiver 110 during a time interval that would have been wasted by prematurely allocating the medium to the second network.

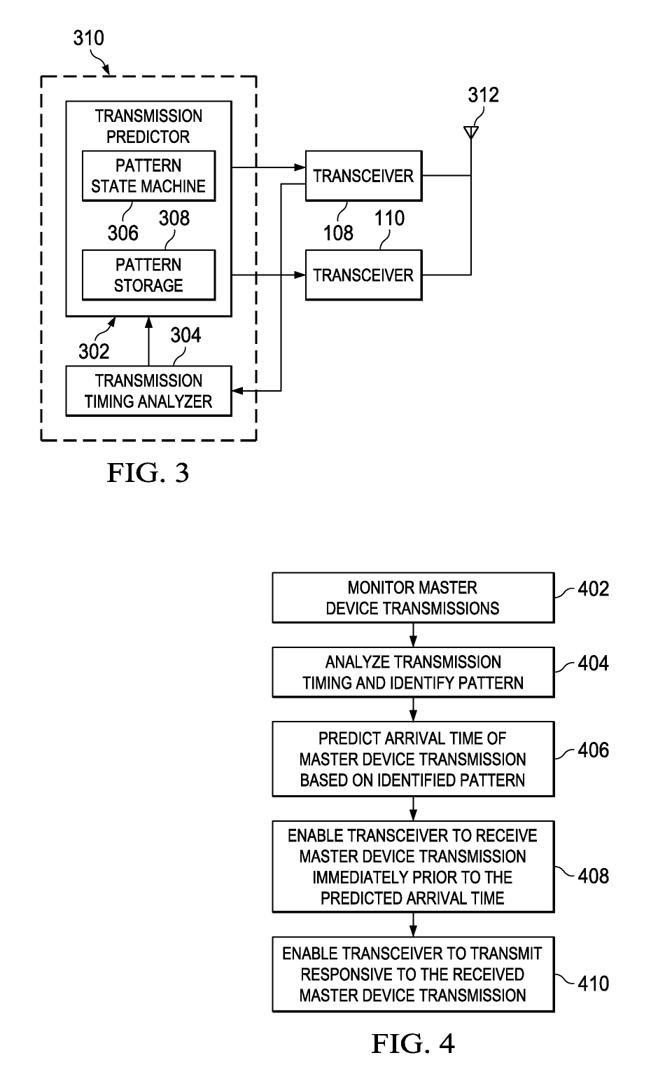

FIG. 3 shows a block diagram of the slave device 106, which is configured for operation on coexisting wireless networks in accordance with various embodiments. The slave device 106 includes transceivers 110 and 108 for accessing the first and second coexisting networks as described above. The transceivers 110, 108 are coupled to one or more antennas 312 that convert signals between airwave and conducted forms. The slave device 106 also includes logic 310 that controls the enabling and disabling of the transceivers 110, 108. The logic 310 includes a master transmission timing analyzer 304 and a master transmission predictor 302.

The master transmission timing analyzer 304 measures the time between successive poll frames 202 transmitted by the master device 102, stores the measured times, and analyzes the measured times to identify a pattern of poll frame 202 transmission timing. For example, based on the measured poll frame intervals the analyzer 304 may identify a pattern wherein the time intervals between poll frames 202 double with each successive poll frame 202 until the slave device 106 transmits a packet, after which the delay preceding the next poll frame 202 is reduced to a smaller initial value. The analyzer 304 may be preprogrammed to recognize various known timing patterns, for example, arithmetic or geometric progressions, exponential functions, etc. Alternatively, the timing analyzer 304 may store the measured time interval associated with (preceding or following) each poll frame 202, allowing the master transmission timing pattern to be estimated by sequentially executing the stored delays. After the transmission timing analyzer 304 identifies the pattern of poll frame 202 transmission, information defining the pattern is transferred to the master transmission predictor 302.

The transceiver 108 may be enabled to receive poll frame 202 transmissions for analysis by the timing analyzer 304 during time periods when the transceiver 110 is not being used or when traffic on the first wireless network is light. In some embodiments of the wireless device 106, the transceiver 108 is disabled from transmitting in response to a received polling frame 202 to induce the master device 102 to time the poll frame 202 transmissions as it would if the transceiver 108 were disabled. Thus, the timing analyzer 304 may be presented with poll frame 202 transmission timing representative of the full range and pattern of transmission timing produced by the master device 102. The analyzer 304 may determine that a complete pattern of poll frame 202 transmission timing has been induced by, for example, identifying a repeated pattern of inter-transmission delays.

The transmission predictor 302 includes storage 308 for storing transmission pattern information collected by the timing analyzer 304, and in some embodiments, includes a pattern state machine 306 for approximating the timing of the master poll frame 202 transmissions. The state machine 306 may be configured to implement the successive poll frame 202 delays measured by the timing analyzer 304 and/or predicted by an identified timing pattern, and to transition to an initial state based on criteria identified by the timing analyzer 304 as setting poll frame 202 transmission timing to an initial state (e.g., a transmission by the transceiver 110 in response to a poll frame 202). By replicating the poll frame 202 transmission timing, the transmission predictor 302 can predict the arrival time of a poll frame 202, and based on the predicted arrival time can, when data is available for transmission in the wireless device 106, enable the transceiver 108 to receive the poll frame 202 shortly before (e.g., <1 ms before) the arrival of the poll frame 202.

For some embodiments of the wireless device 102, e.g., Bluetooth embodiments, the predicted arrival time may be accurate to within tens of microseconds. Bluetooth scheduling is based on 625 microsecond long slots. the timing of which is known to the wireless device 106. For a Bluetooth device, the intervals between poll frames 202 are transmitted at a multiple of the slot time. Consequently, for such embodiments, the transmission predictor 302 can enable the transceiver 108 to receive the poll frame 202 100 microseconds or less prior to the predicted arrival time.

Some embodiments of the transmission predictor 302 predict the completion time of the poll frame 202 rather than or in addition to the arrival time. Such embodiments can extend the time allocated to the first wireless network by enabling transceiver 110 through the predicted poll frame 202, and enabling the transceiver 108 (and disabling the transceiver 110) after the predicted completion of the poll frame 202.

Some embodiments of the transmission predictor 302 may include a neural network. The timing information acquired by the transmission timing analyzer 304 can be provided to the neural network, and neural network can output a predicted arrival time based on the timing information.

Some embodiments of the wireless device 102 can be identified by information provided from the device 102, for example a media access controller address or device ID. If the logic 310 has previously identified and stored a transmission timing pattern for the device 102 and the transmission pattern of the device 102 is fixed, then the logic 310 need not reanalyze the transmission timing, but can instead predict poll frame 202 arrival times based on the previously identified pattern. In some embodiments, timing patterns used by various embodiments of the device 102 are preprogrammed into the pattern storage 308.

Various components of the wireless device 106, including at least some portions of the transceivers 110, 108, the master transmission predictor 302, and the master transmission timing analyzer 304, can be implemented using a processor and software programming that causes the processor to perform the operations described herein. In particular, software programming can be used to cause a processor to detect reception of poll frames 202, to measure the time interval between poll frames 202, and to identify the pattern of poll frame 202 transmission timing used by the master device 102. Similarly, software programming can be used to cause a processor to predict the arrival time of an expected poll frame 202 based on the identified pattern, and to control the transceivers 110, 108 based on the prediction. Suitable processors include, for example, general-purpose processors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming executable by a processor can be stored in a computer readable storage medium. A computer readable storage medium comprises volatile storage such as random access memory, non-volatile storage (e.g., a hard drive, an optical storage device (e.g., CD or DVD), FLASH storage, or combinations thereof.

Some embodiments can implement the functionality described herein using dedicated circuitry. Some embodiments may use a combination of dedicated circuitry and software executed by a processor. Selection of a hardware or software/processor implementation of embodiments is a design choice based on a variety of factors, such as cost and the ability to incorporate changed or additional functionality in the future.

FIG. 4 shows a flow diagram for a method of controlling access to coexisting wireless networks in the slave device 106 in accordance with various embodiments. Though depicted sequentially as a matter of convenience, at least some of the actions shown can be performed in a different order and/or performed in parallel. Additionally, some embodiments may perform only some of the actions shown. In some embodiments, the operations of FIG. 4, as well as other operations described herein, can be implemented as instructions stored in a computer readable medium and executed by a processor.

In block 402, the system 100 is operating. The master device 102 is transmitting poll frames 202 on the second wireless network. The slave device 106 may transmit on the second wireless network responsive to receiving a poll frame 202. The slave device 106 is monitoring the master device 102 poll frame 202 transmissions. The transceiver 108 of the slave device 106 is enabled to receive the transmissions, and may be disabled from transmitting to induce the master device 102 to produce a complete pattern of poll frame 202 transmission timing.

In block 404, the slave device 106 measures the time delays between received poll frame 202 transmissions and analyzes the measured delays to identify a pattern of poll frame 202 transmission timing used by the master device 102. Information defining the measured delays and the identified pattern may be used to approximate the transmission timing and predict the arrival time of a poll frame 202.

In block 406, the slave device 106 is internally replicating the poll frame 202 timing pattern of the master device 102. The slave device 106 can predict the arrival of a poll frame 202 transmission based the previously identified poll frame 202 transmission timing pattern. In some embodiments, the acquired delay and pattern information may be used to configure a state machine 306 in the slave device 106. The state machine 306 approximately reproduces the master device 102 poll frame 202 transmission timing pattern.

In block 408, the slave device 106 has data available for transmission on the second wireless network. Based on a predicted arrival time of a poll frame 202, the slave device 106 enables the transceiver 108 to receive the poll frame 202 transmission from the master device 102 immediately prior to the predicted arrival time of the poll frame 202. The transceiver 110 of the slave device 106 remains enabled until the transceiver 108 is enabled, thereby providing additional access to the first network and optimizing use of the medium.

In block 410, the slave device 106 receives the poll frame 202 transmitted by the master device 102, and responsive to the received poll frame 202 enables the transceiver 108 to transmit a data packet 208.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless device, comprising:
a first wireless transceiver and a second wireless transceiver, the first wireless transceiver configured for operation with a first wireless network, and the second wireless transceiver configured for operation with a second wireless network coexisting with the first wireless network; and
logic configured to determine which of the first and second wireless transceivers is enabled at a given time;
wherein the logic is further configured to predict an arrival time of a transmission from a different device and to enable the second wireless transceiver based on the predicted arrival time.

2. The wireless device of claim 1, wherein the logic is configured to monitor transmissions of the different device, and based on the monitoring, to identify a timing pattern of the transmissions.

3. The wireless device of claim 2, wherein the logic is configured to identify a timing pattern of the transmissions wherein the timing differs between transmissions.

4. The wireless device of claim 1, wherein the logic is configured to enable the second wireless transceiver to receive a transmission from the different device based on data being available for transmission by the second transceiver.

5. The wireless device of claim 1, wherein the logic is configured to enable the second wireless transceiver a predetermined time prior to the predicted arrival time.

6. The wireless device of claim 1, wherein the logic is configured to predict the arrival time based on a learned pattern of transmissions of the different device.

7. The wireless device of claim 1, wherein the logic is configured to enable the first wireless transceiver to transmit until a predetermined time prior to the predicted arrival time.

8. The wireless device of claim 1, wherein the logic is configured to disable transmission by the second wireless transceiver until a transmission pattern of the different device is identified.

9. The wireless device of claim 1, wherein the logic comprises a state machine configured to generate aperiodic transmission timing of the different device.

10. A method, comprising:
determining, by a first wireless device, a predicted arrival time of a transmission from a second wireless device; and
enabling a first wireless transceiver in the first wireless device based on the predicted arrival time.

11. The method of claim 10, further comprising enabling a second wireless transceiver in the first wireless device until a predetermined time prior to the predicted arrival time.

12. The method of claim 10, further comprising monitoring transmissions emitted by the second wireless device, and identifying a timing pattern of the transmissions.

13. The method of claim 10, wherein determining the predicted arrival time is based on a learning, by the first device, a pattern of transmissions emitted by the second wireless device.

14. The method of claim 10, further comprising disabling transmitting by the first transceiver until a timing pattern of transmissions emitted by the second wireless device is identified.

15. The method of claim 10, further comprising configuring a state machine to generate the timing of transmissions emitted by the second wireless device.

16. A system, comprising:
a master wireless device; and
a slave wireless device;
wherein the slave wireless device is configured to operate on a first wireless network and to operate on a second wireless network different from the first wireless network;
wherein the master wireless device is configured to emit transmissions determining when the slave device transmits on the second network; and
wherein the slave device is further configured to predict an arrival time of a transmission by the master device, and to enable operation on the second network based on the predicted arrival time.

17. The system of claim 16, wherein the slave device is configured to monitor the transmissions emitted by the master device, and to identify a timing pattern of the transmissions.

18. The system of claim 16, wherein the slave device is configured to enable operation on the second network a predetermined time prior to the predicted arrival time.

19. The system of claim 16, wherein the slave device is configured to record the identified timing pattern and to determine the predicted arrival time by replicating the timing pattern.

20. An apparatus, comprising:
a transmission analyzer configured to gather timing information associated with transmissions by a master device; and
a transmission predictor configured to determine an estimated arrival time of a transmission by the master device based on the gathered timing information.

21. The apparatus of claim 20, wherein the transmission analyzer is configured to record time intervals occurring between poll frame transmissions by the master device.

22. The apparatus of claim 20, wherein the transmission analyzer is configured to identify a pattern of transmission timing used by the master device.

23. The apparatus of claim 20, wherein the transmission predictor is configured to estimate the arrival time of a poll frame transmission by the master device by executing time delays recorded by the transmission analyzer.

24. The apparatus of claim 20, wherein the transmission predictor is configured to enable a first transceiver to receive a transmission from the master device on a first network based on the estimated arrival time, and to enable a second transceiver to operate on a second network while awaiting the estimated arrival time.

25. The apparatus of claim 20, wherein the transmission predictor is configured to identify the master device, and to select and apply previously gathered timing information to determine the estimated arrival time based on the identification of the master device.

26. The apparatus of claim 20, wherein the transmission predictor is configured to estimate a completion time of the transmission, and to enable, based on the estimate, a first transceiver to transmit on a first network after the estimated completion time, and to enable a second transceiver to operate on a second network while awaiting the estimated completion time.
